(19) United States
(12) Patent Application Publication
(10) Pub. No.: US 2024/0206389 A1
(43) Pub. Date: Jun. 27, 2024

(54) Harvester Cutter

(71) Applicant: EHS MANUFACTURING PTY LTD, Cranbourne, Victoria (AU)

(72) Inventor: Steven Lawn, Cranbourne, Victoria (AU)

(21) Appl. No.: 18/547,065

(22) PCT Filed: Feb. 21, 2022
(86) PCT No.: PCT/AU2022/050122

§ 371 Date: Aug. 18, 2023

(30) Foreign Application Priority Data
Feb. 19, 2021 (AU) 2021900446

(51) Int. Cl. A01D 34/73; A01D 34/66

(52) U.S. Cl. CPC A01D 34/733; A01D 34/66

(57) ABSTRACT

A harvester cutter 1 including a rotating cutter 10, the rotating cutter 10 including a blade 20, wherein; a leading edge 21 of the blade 20 is located further up a rotational 11 axis of the rotating cutter 10 than a trailing edge 22 of the blade 20 at any radial location on a cutting portion 23 of the blade 20 relative to the rotational axis 11 of the rotating cutter 10.

### CROSS REFERENCE TO RELATED APPLICATIONS

This application is a national phase entry under 35 U.S.C. § 371 of International Patent Application PCT/AU2022/050122, filed Feb. 21, 2022, designating the United States of America and published in English as International Patent Publication WO 2022/174303 on Aug. 25, 2022, which claims the benefit under Article 8 of the Patent Cooperation Treaty to Australian Patent Application Serial No. 2021900446, filed Feb. 19, 2021, the entireties of which are hereby incorporated by reference.

### FIELD OF INVENTION

This invention relates to a harvester cutter including a raked blade.

### BACKGROUND ART

The following references to and descriptions of prior proposals or products are not intended to be, and are not to be construed as, statements or admissions of common general knowledge in the art. In particular, the following prior art discussion should not be assumed to relate to what is commonly or well known by the person skilled in the art, but to assist in the inventive process undertaken by the inventor(s) and in the understanding of the invention.

Harvester cutters have been described in which a cutter blade is used which is orientated parallel to a ground when harvesting. The cutter blades contact substrate in the ground dulling the blade. Furthermore, the blades parallel to the ground pickup substrate which is collected by the harvester, creating impurities in the harvested product.

An object of the present invention is to ameliorate one or more of the aforementioned disadvantages of the prior art or to at least provide a useful alternative thereto.

### STATEMENT OF INVENTION

The invention according to one or more aspects may be as defined in the independent claims. Some optional and/or preferred features of the invention are defined in the dependent claims.

Accordingly, in one aspect of the invention there is provided:

A harvester cutter including a rotating cutter, the rotating cutter including a blade, wherein: a leading edge of the blade is adapted located further along a rotational axis of the rotating cutter than a trailing edge of the blade away from the substrate at any radial location on the blade relative to the rotational axis of the rotating cutter.

In another aspect of the same invention, there is provided:
a rotatable cutter for a harvester, the rotatable cutter including a blade extending in a direction substantially radially outward from a rotational axis of the rotatable cutter, the rotatable cutter adapted to rotate in a first direction and the blade position to substantially lie in a plane extending radially and perpendicular to the rotational axis, wherein:
the blade is tilted so that a part of the blade intermediate its width is intersected by the plane;
a leading edge of the blade facing the first direction is located above the plane; and
a trailing edge of the blade facing away from the first direction is located below the plane, whereby the rotatable cutter is adapted to self-sharpen the leading edge and/or the trailing edge against produce as it wears.

### Harvester Cutter

The harvester cutter may be adapted to harvest sugar cane. The harvester cutter may be adapted to harvest any produce such as wheat or other grains. The harvester cutter may include multiple rotating cutters. Preferably, the harvester cutter includes 2 harvester cutters which include blades that either rotate on paths that overlap as viewed from above, or intersect. The blades may interact to cut the produce.

### Rotating Cutter

The rotating cutter may include a disc or other device adapted to rotate and receive the blade. The rotational axis of the rotating cutter may be aligned to the vertical. The rotational axis of the rotating cutter may be orientated at an angle to the vertical or non-vertical.

As a consequence of the angle of the rotating cutter, a combination of the forward motion of a vehicle (such as a harvester) the rotation of the cutter may serve to sharpen the trailing edge of the blade, which can be reversed during maintenance to present a sharpened leading blade edge. This has the effect of reducing the time spent on maintenance of the blades.

On a standard disc, as the harvester moves in the forward direction there is a positive shoveling effect of the substrate. The orientation of the blades in the present invention away from the ground also reduces the abrading effect on the leading blade edge as the blade encounters less ground-based stones, sticks and other hard and abrasive debris. This has the effect of lengthening the blade's service life.

The blade according to the invention preferably has a negative rake. The negative rake is considered by the Applicant to create a negative shoveling effect on the forward motion of the harvester.

As well as the rotation of the blade, each blade may move forward by between 15 mm to 50 mm caused by the forward motion of the harvester. Examples of the geometry of the blade when mounted with a negative rake to the disc are represented in the drawings. Applicant calculated a negative rake range based on a theory of efficacy and trials have demonstrated significant advantages beyond what was expected.

### Blade

The blade may be adapted to be orientated at an angle to the ground. A longitudinal axis of the blade may be orientated perpendicular to the longitudinal axis of the rotating cutter. The blade may be orientated in a position rotated about its longitudinal axis. The blade may be orientated at between 1 and 10 degrees from a horizontal plane in the rotational direction around the blade's longitudinal axis, preferably, 2-5 degrees, most preferably, 2.5-4 degrees. The blade may then further be angled at an angle to the longitudinal axis of the rotating cutter. The blade may therefore also be angled downwards or upwards. Preferably, the blade is only angled from the horizontal around the blade's longitudinal axis.

Preferably, the blade is a double-edged blade. Preferably, the blade is adapted to be installed to cut with a first side of the blade and then re-installed during maintenance in a reverse position to cut with a second side of the blade.

The orientation of the blade may allow the leading an/or the trailing side of the blade to be sharpened on the substrate as the leading side of the blade is being used to cut the produce. Therefore, the blade may be a self-sharpening blade in use. Advantageously, the orientation of the blade with the leading side higher than the trailing side may reduce dulling of the blade at its peripheral edge. As the underside surface immediately adjacent the leading edge is inclined away from the approaching (in relative terms) produce, abrading produce will therefore tend to drag across the underside surface to wear the lower edge of the leading edge away, thereby sharpening the edge. The trailing side of the blade may be adapted to touch or scrape on the substrate to also sharpen the trailing edge. The tilting of the blade may be adapted to maintain the leading side of the blade at a position above the substrate. The blade may be angled to the horizontal where horizontal is perpendicular to the rotational axis. Advantageously, the blade may be angled relative to the horizontal about the longitudinal axis of the blade. This reverse aerofoil-type arrangement may create a down draft to reduce substrate, such as dust, soil, debris and lighter fractions, getting drawn into the harvester, so that there is resistance against such debris getting harvested with the produce.

It will be appreciated that any of the features described herein can be used in any combination, and that the invention as described in respect of the second aspect may have the specific features referred to above in respect of the invention as described in respect of the first aspect.

### BRIEF DESCRIPTION OF THE DRAWINGS

The invention may be better understood from the following non-limiting description of preferred embodiments, in which:

FIG. 1 is an isometric view of two rotating cutters;

FIG. 2 is a front view of a rotating cutter;

FIG. 3a is an isometric top view of the two rotating cutters;

FIGS. 3b-c are top plan views of the rotating cutters of FIG. 1;

FIG. 3d is an end elevation of the cutters shown in FIG. 3c;

FIG. 4 is an end elevation of the rotating cutter shown in FIG. 3c;

FIG. 5 is a magnified view B of a blade on the rotating cutter shown in FIG. 4; and

FIGS. 6a-6cii are plan views and accompanying sectional end and side views of three blade variations according to the invention.

### DETAILED DESCRIPTION OF THE DRAWINGS

Preferred features of the present invention will now be described with particular reference to the accompanying drawings. However, it is to be understood that the features illustrated in and described with reference to the drawings are not to be construed as limiting on the scope of the invention. In describing the various embodiments of the invention, like features will be referred to using like references, with references for features of each embodiment generally preceded by 1, 2, 3, or followed by a Roman numeric sequence, such as i, ii, iii, etc. or an alphabetical sequence such as a, b, c, relative to the corresponding feature of the first embodiment. For example, a feature 10 of the first embodiment may represented as 110, 210, 310, (or n10), or 10a, 10b, 10c, (or 10x) or 10i, 10ii, 10iii, (or 10r) etc. in second, third and fourth embodiments, respectively.

| Ref | Description |
|---|---|
| 1 | Harvest cutter |
| R | Central axis |
| 10 | Rotating cutter |
| 10a- | Rotating disc |
| 10b | Rotating disc |
| 11 | Rotational axis |
| 20 | Blade |
| 20a | Single sharp edge blade |
| 20b | Double sharp edge blade |
| 21 | Leading edge |
| 22 | Trailing edge |
| 23 | Cutting portion |
| 24 | Sharp edge |
| 25 | Long axis of blade |
| 26 | Blade underside |
| 27 | Upper surface |
| 28 | Blade outer corners |
| 29 | Outer edge |
| 29a | Leading outer corner edge |
| 29b | Outer edge extending from 29a |
| 30 | Mounting means |
| 31 | Main body |
| 32 | Bolts |
| 34 | Apertures |
| 35 | First pair of apertures |
| 36 | Progressively inward pairs of apertures |

A harvester cutter 1 including a rotating cutter 10, the rotating cutter 10 including a blade (generally referenced 20), wherein; a leading edge 21 of the blade 20 is located further up a rotational axis 11 of the rotating cutter 10 than a trailing edge 22 of the blade 20 at any radial location on a cutting portion 23 of the blade 20 relative to the rotational axis 11 of the rotating cutter 10.

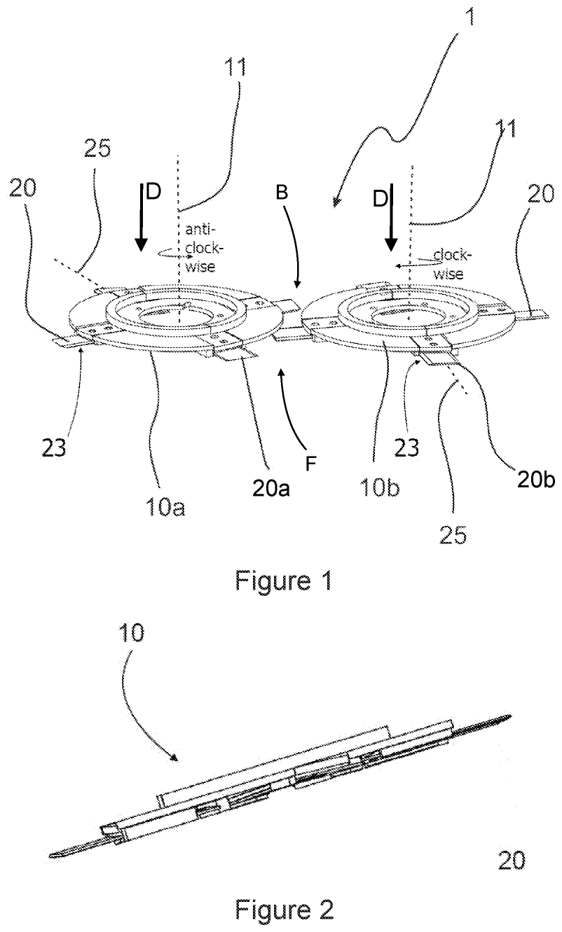

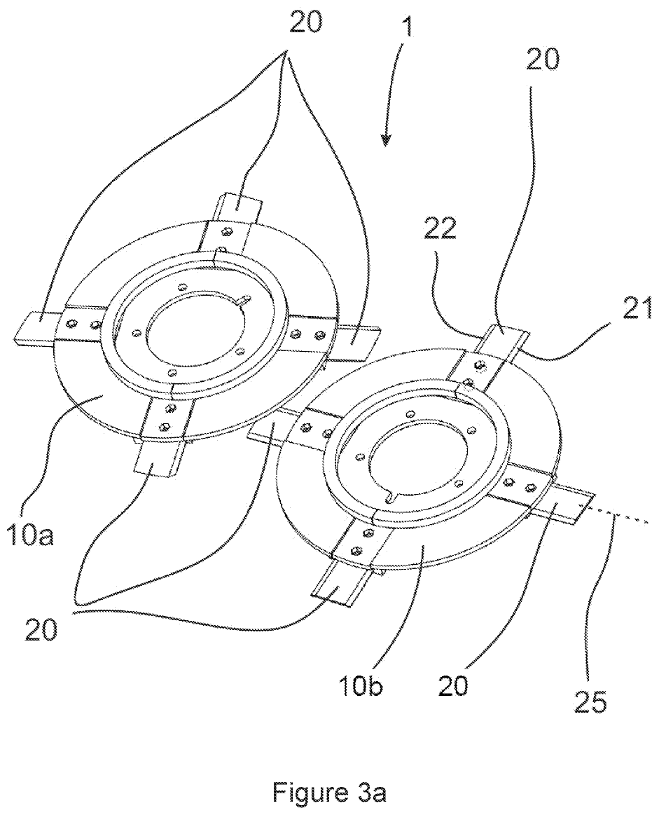

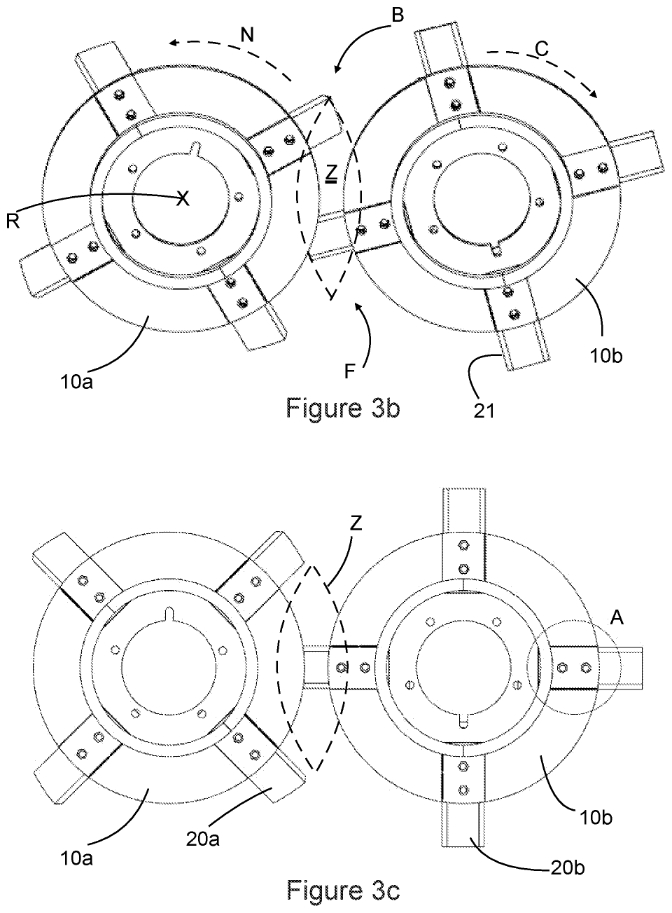

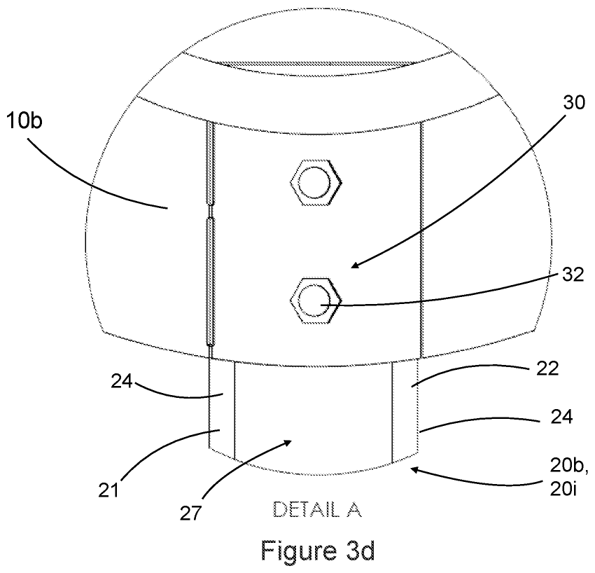

The harvester cutter 1 includes two rotating discs 10a,b. The rotating cutter discs 10a,b are adapted to rotate in opposite directions. As shown in FIGS. 1 and 3a-c, the rotating cutter 10a is rotatable in an anticlockwise direction N and rotating cutter 10b is shown as rotatable in a clockwise direction C, so that the leading edges 21 of the respective blades 20 rotate towards each other in the foreground F prior to reaching an overlapping zone Z. The trailing edges 22 move away from each other in the background B. In this specification, any reference to a singular rotating cutter includes a reference to one rotating cutter 10, or the pair of complementary and counter-rotating rotating cutters 10a,b.

Each rotating cutter 10a,b is adapted to receive 4 blades 20. As shown in inter alia FIGS. 3c-d, the blades 20b on one of the rotating cutters 10b or both of the rotating cutters 10a-b may include a sharp edge 24 on both the leading edge 21 and the trailing edge 22 of their respective blades 20b. Preferably, the blades 20b mounted on both rotating cutters 10,b may all be double-edged in that they have sharp edges 24 on both the leading and trailing edges 21,22. The provision of double edged blades 20b is advantageous according to the invention as it allows the trailing edge 22 to actually be sharpened in normal use whilst the leading edge 21 is being blunted by normal use, so that the blades 20b are adapted to be self-sharpening. This may best be achieved by tilting the blades 20b about the long axis 25, so that the trailing edge 22 drags and the lower surface of the blade's underside 26 is exposed to abrading stones, grit, raw product whereby to wear the underside surface 26 and so sharpen the sharp edge 24 of the trailing edge 22. Prior to-use and any wear caused by use, etc., the underside surface 26 may be a flat broad surface whilst the upper blade surface 27 may terminate at each side peripheral leading or trailing edge 21,22 by a taper forming the sharpened edges 24. In the single sharp edge blades 20a, the trailing edge 22 may be a broad and thick non-sharpened edge. However, the blades 20a may be tilted about the long axis 25 whereby the natural abrading of the trailing edge 22 during use develops a sharpened edge or works towards a tapered edge 28. The naturally tapered edge 28 may be further machined to obtain a desirable taper prior to deployment as a leading edge 21 prior remounting on the cutter disc 10b in a flipped or reverse orientation in which the previously leading edge 21 is mounted as the trailing edge 22.

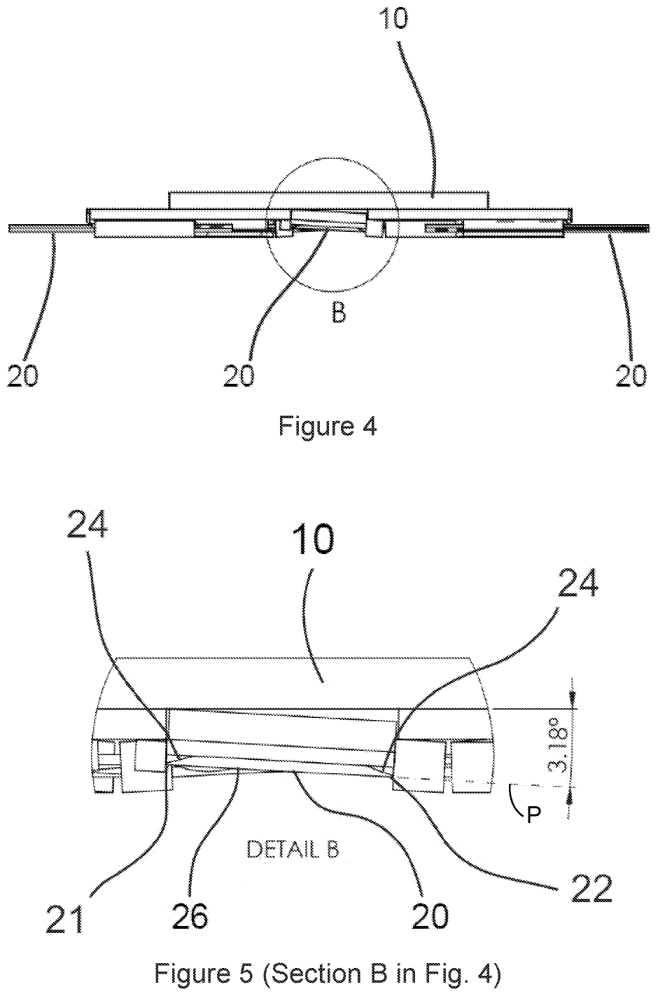

As shown in FIG. 5, the longitudinal axis 25 of the blades 20 is each orientated perpendicular to the rotational axis 11 of the rotating cutters 10a,b. Where the blades 20 are tilted about the long axis 25, a main plane P of the blades 20 is orientated at a slight angle (between 1-10º) to the horizontal. Preferably, the angle is 3.18 degrees from the horizontal as shown in FIG. 5.

The underside 26 of the blades 20 is adapted to contact substrate non-usable material such as soil and debris as the blades 20 rotate. The contact with the substrate in combination with the high rotational speed of the blades 20, means that the blades 20 are adapted to be sharpened in situ. In particular, the trailing edge 22 of the blades 20 is therefore adapted to be sharpened in use. This is especially advantageous as the blades 20a can be exchanged with blades 20b on the other of the two rotating cutters 10a,b to make the leading edge 21 the trailing edge 22 and the trailing edge 22 the leading edge 21. This alternating of the leading edge 21 in combination with the blade 20 orientation is adapted to keeps the leading edge 21 sharp through use, thereby creating a self-sharpening blade 20.

Furthermore, the blades 20 are adapted to create a down draft due to their orientation. The angled fan blade like orientation of the blades 20 creates a down draft D. The down draft D has the effect of reducing the amount of substrate (debris) that gets mixed in with the produce. Preferably, the produce is sugar cane.

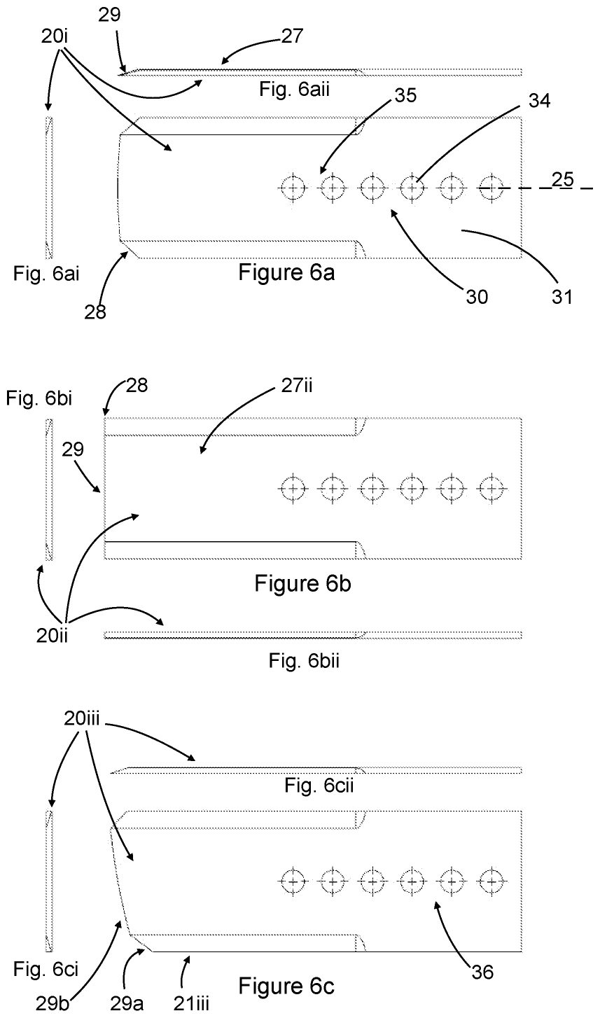

Referring to FIGS. 6a-6cii, there is shown several double edged blade configurations 20i-iii. FIG. 6a shows an evenly worn blade 20i in which the outer corners 28 of both edges 21,22 are fairly evenly worn. Alternatively, the blade 20i may be machined to this shape before use, whereby to reduce the shock and wear that would otherwise be occasioned by square corned blades 20ii shown in FIG. 6b. This may minimise shock and fatigue in the mounting structures 30, such as threaded bolts 32 shown in FIG. 3d. The mounting means 30 further includes, on the main body 31 of the blade 20i, a series of apertures, preferably extending along or parallel to the long axis 25. There are a plurality of apertures 34, preferably between 3-7, that allow the blade 20 to mounted closer or further away from the rotating cutter's 10 central axis R. Therefore, as the outer edge 29 is gradually worn and the length of the blade 20 along the long axis 25 gradually shortens, the mounting means 30 may be adjusted to keep the outer edge 29 consistently spaced from the central axis R in a desirable range of radii, relative to the central axis R. Typically, the first two apertures 35 closest to the outer edge 29 would be used to mount the blade 20i. As the blade 20 wears and the length of the blade along the long axis 25 shortens, progressively pairs of apertures 36 closer to an inner edge 36 of the main body 31 can be used to mount the blade 20.

FIGS. 6b-6bii show a blade 20ii where the corners 28 are square and have not been radiused or rounded, either by natural wear or deliberate machining or a combination of both. Unlike the outer edge 29 in blade configuration 20i where the upper surface 27 is tapered toward the outer edge 29, the upper surface 27ii is not tapered towards the outer edge 29.

FIGS. 6c-6cii shows a third blade configuration 20iii in which respective corners 28 are asymmetrically worn. In this case, advantageously the blade 20iii may be mounted to the other of the rotating discs 10a,b, so that what was the leading edge 21iii becomes the trailing edge, so that what was the trailing edge 22iii is exposed as the leading edge and the outer edge 29 can be worn further by use. Therefore, the exchangeability of the blades 20 allows for considerably extended life of the blades 20 and minimises machining maintenance of the blades 20, thereby leading to extended life of the blades 20 and improved productivity.

In the specification, the term “substrate” includes within its scope plant-based product to be harvested.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features not specifically listed, unless the contrary is expressly stated or the context requires otherwise.

In the present specification, terms such as “apparatus”, “means”, “device” and “member” may refer to singular or plural items and are terms intended to refer to a set of properties, functions or characteristics performed by one or more items or components having one or more parts. It is envisaged that where an “apparatus”, “means”, “device” or “member” or similar term is described as being a unitary object, then a functionally equivalent object having multiple components is considered to fall within the scope of the term, and similarly, where an “apparatus”, “assembly”, “means”, “device” or “member” is described as having multiple components, a functionally equivalent but unitary object is also considered to fall within the scope of the term, unless the contrary is expressly stated or the context requires otherwise. In the present specification, the phrase “and/or” refers to severally or any combination of the features. For example, the phrase “feature 1, feature 2 and/or feature 3” includes within its scope any one of the following combinations: Feature 1 or feature 2 or feature 3; feature 1 and feature 2 or feature 3; feature 1 or feature 2 and feature 3; feature 1 and feature 3 or feature 2; feature 1 and feature 2 and feature 3.

The meaning of descriptive, precise or absolute terms such as “flexed”, “normal”, “parallel”, “horizontal”, “vertical” or “fully” includes the preceding qualifier “substantially or almost”, unless the context or contrary is expressly indicated.

Qualifying relative terms, such as “relatively”, “sufficiently”, “near”, “almost” or “substantially”, may be taken to indicate a variation in an absolute value of between 0° and 10° or between 0% and 10%, relative to the absolute value. For example, “near horizontal” may be taken to mean any orientation between 0° and 10° relative to the horizontal.

Where the word “for” is used to qualify a use or application of an object term, the word “for” is only limiting in the sense that the device or component should be “suitable for” that use or application.

Orientational terms used in the specification and claims such as vertical, horizontal, top, bottom, upper and lower are to be interpreted as relational and are based on the premise that the component, item, article, apparatus, device or instrument will usually be considered in a particular orientation, which will usually be apparent from the context.

In the present specification, the term “integral” means formed of one body in a single process. In particular, the term “integrally formed” means formed of the one body without post-forming attachment of separately formed component parts. That is, “integrally formed” and the similar term “unitarily formed” mean formed in a single forming process and do not include post-forming attachment of component parts by means of fastener or other component fixing substances or methods.

The articles “a” and “an” are used herein to refer to one or to more than one (i.e. to at least one) of the grammatical object of the article. By way of example, “an element” means one element or more than one element.

It will be appreciated by those skilled in the art that many modifications and variations may be made to the methods of the invention described herein without departing from the spirit and scope of the invention. The features and components of each of the embodiments of the invention described in the detailed description and/or depicted in the accompanying drawings may be interchangeable as required, with regard to functional equivalency and compatibility. A feature or component described with reference to one but not all embodiments, if functionally and dimensionally compatible as an addition with another embodiment herein described, or substitutable with a corresponding feature or component of that other embodiment in relation to which it has not been expressly described, should be read as a potential addition or substitution to that other embodiment and as being within the scope of the invention. Furthermore, in considering a feature or component that is described in relation a particular embodiment but may be omitted from the embodiment without losing the functionality characterising the invention and without departing from the scope of the invention, unless the context and expressions used in describing the embodiment imputes that the feature or component is essential to the invention as broadly described, the omittable feature or component may be read as not being included in the embodiment.

1. A rotatable cutter for a harvester, the rotatable cutter including a blade, wherein a leading edge of the blade is located further up a rotational axis of the rotatable cutter than a trailing edge of the blade at any radial location on the blade relative to the rotational axis of the rotating cutter.

2. The rotatable cutter as claimed in claim 1, wherein the blade is adapted to be rotated about its longitudinal axis relative to horizontal.

3. The rotatable cutter as claimed in claim 1, the rotatable cutter being a first one of a multiple of rotatable cutters.

4. The rotatable cutter as claimed in claim 3, wherein the multiple rotatable cutters include a pair of rotatable cutters including the first rotatable cutter and a second rotatable cutter, the pair of rotatable cutters including multiple blades including the blade, the multiple blades adapted to rotate on paths that overlap as viewed from above.

5. The rotatable cutter as claimed in claim 3 wherein the second rotatable cutter is adapted to rotate in an opposite direction to the first rotatable cutter.

6. The rotatable cutter as claimed in claim 4, wherein each of the multiple blades is a double edge blade and a trailing edge of each of the multiple blades is self sharpening due to being closer than a leading edge to a substrate when in operation.

7. The rotatable cutter as claimed in claim 6, wherein the multiple blades are adapted to be reversable or flipped such that the leading edge becomes the trailing edge and the trailing edge becomes the leading edge.

8. The rotatable cutter as claimed in claim 1, wherein the blade is orientated at a fan blade like angle between 1 and 10 degrees.

9. The rotatable cutter as claimed in claim 8, wherein the multiple blades are adapted to create a downdraft in operation.

10. The rotatable cutter as claimed in claim 1, wherein the rotatable cutter includes a disc adapted to rotate and to receive the blade.

11. A rotatable cutter for a harvester, the rotatable cutter including a blade extending in a direction substantially radially outward from a rotational axis of the rotatable cutter, the rotatable cutter adapted to rotate in a first direction, the blade position adapted to substantially lie in a plane extending radially and perpendicular to the rotational axis,
wherein:
the blade is tilted so that a part of the blade intermediate its width is intersected by the plane;
a leading edge of the blade facing the first direction is located above the plane; and
a trailing edge of the blade facing away from the first direction is located below the plane, whereby the rotatable cutter is adapted to self-sharpen the leading edge and/or the trailing edge against produce as it wears.

12. A rotatable cutter as claimed in claim 11, wherein, as a consequence of the angle of the rotating cutter having a negative rake, in combination with the forward motion of the harvester, the rotation of the cutter sharpens the trailing edge of the blade.

13. A rotatable cutter as claimed in claim 11, wherein the blade is angled at between 1 and 10 degrees from a horizontal plane in the rotational direction around the blade's rotational axis.

14. A rotatable cutter as claimed in claim 11, wherein the blade is a double-edged blade that is adapted to be installed to cut with a first side of the blade and then re-installed during maintenance in a reverse position to cut with a second side of the blade.

15. The rotatable cutter as claimed in claim 1, wherein the rotatable cutter is mounted in a reverse aerofoil-type arrangement that is adapted to create a down draft to reduce substrate getting drawn into the harvester and mixing with the produce.

16. A rotatable cutter as claimed in claim 11, wherein the leading edge of the blade is located further up the rotational axis than the trailing edge at any radial location on a cutting portion of the blade relative to the rotational axis.

17. A rotatable cutter as claimed in claim 11, wherein the rotatable cutter is a first rotatable cutter of two rotatable cutters comprising two corresponding rotating discs adapted to rotate in opposite directions.

18. A rotatable cutter as claimed claim 16, wherein each rotatable cutter is adapted to receive blades that are double-edged in that they have sharp edges on both the leading and trailing edges.

19. A rotatable cutter as claimed in claim 11, wherein the blade is tilted about a longitudinal axis of the blade, so that the trailing edge is adapted to drag and the lower surface of the blade's underside is adapted to be exposed to abrading product whereby to wear the underside surface and so sharpen the sharp edge of the trailing edge.

20. A rotatable cutter as claimed in claim 11, wherein a main body of the blade includes a series of apertures extending along or parallel to the longitudinal axis that allow the blade to mounted closer or further away from the rotational axis.
